(19) United States
(12) Patent Application Publication
(10) Pub. No.: US 2024/0269596 A1
(43) Pub. Date: Aug. 15, 2024

(54) DUST REMOVAL DETERMINATION DEVICE, DUST REMOVAL DEVICE, AND DUST REMOVAL DETERMINATION METHOD

(71) Applicant: NIPPON TELEGRAPH AND TELEPHONE CORPORATION, Tokyo (JP)

(72) Inventors: Wataru ITO, Tokyo (JP); Daisuke UCHIBORI, Tokyo (JP); Yusuke YOSHIMURA, Tokyo (JP); Junichiro TAMAMATSU, Tokyo (JP)

(73) Assignee: NIPPON TELEGRAPH AND TELEPHONE CORPORATION, Tokyo (JP)

(21) Appl. No.: 18/565,120

(22) PCT Filed: Jun. 1, 2021
(86) PCT No.: PCT/JP2021/020907

§ 371 Date: Nov. 29, 2023

(51) Int. Cl. B01D 46/48; G01N 15/06

(52) U.S. Cl. CPC B01D 46/48; G01N 15/06

(57) ABSTRACT

A dust removal determination device (10) includes: a measurement value acquisition part (112) that acquires a plurality of measurement values at predetermined time intervals of humidity in a structure including an oxygen concentration measurement device (40); a decision part (113) that decides whether or not the humidity is less than a reference value by using the measurement values; and a signal generation part (114) that generates a signal instructing removal of dirt on the oxygen concentration measurement device (40) according to the decision of the decision part (113).

### TECHNICAL FIELD

The present disclosure relates to a dust removal determination device, a dust removal device, and a dust removal determination method.

### BACKGROUND ART

Conventionally, when measuring the oxygen concentration in structures such as cable tunnels, oxygen concentration measurement devices have been put into practical use. As one kind of oxygen concentration measurement device, there is a zirconia type (limiting current type) oxygen concentration measurement device. As disclosed in NPL 1 and NPL 2, the zirconia type oxygen concentration measurement device measures the oxygen concentration by bringing outside air into contact with a sensor using zirconia and reacting the sensor. In addition, the zirconia type oxygen concentration measurement device has a structure in which outside air is sucked into the device and reacted with a sensor. Therefore, when impurities such as dust adhere to the sensor, there is a problem that the structure of the gas diffusion hole of the sensor changes, the reaction that occurs is hindered, and a value lower than the true oxygen concentration is output. As a countermeasure for this, a method is employed in which a filter is provided at a suction port through which outside air passes before it reaches a sensor, and impurities such as dust are prevented from adhering to the sensor, thereby preventing deterioration of the sensor.

However, if dust or the like adheres to the filter and continues to remain, suction of oxygen is hindered, making it difficult to accurately measure the oxygen concentration. As a countermeasure for this, a countermeasure for replacing a filter and cleaning the filter manually using a tool is considered, but when a large number of oxygen concentration measurement devices are installed or when they are not installed within easy reach for inspection, a huge cost is incurred to inspect each oxygen concentration measurement device. Therefore, a device capable of automatically removing dirt such as dust has been desired.

### CITATION LIST

### Non Patent Literature

[NPL 1] Mitsuhiro Nakazawa, and one others, “Development of Limiting Current Type Zirconia Oxygen Sensor,” Denki kagaku 60(7), pp. 613-616, 1992
[NPL 2] Keiichi Saji, and two others, “Development of Limiting Current Type Zirconia Oxygen Sensor,” Denki kagaku 60(7), pp. 608-612, 1992
[NPL 3] Tateki Mizuno, and one others, “Relation between Concentration of Suspended Particulates and Relative Humidity in Early Winter,” Journal of Japan Society of Air Pollution 25(6), pp. 395-404, 1990

### SUMMARY OF INVENTION

### Technical Problem

Here, when the device is mounted on a device related to human life such as an oxygen concentration measurement device, it is necessary to surely prevent malfunction due to adhesion of dust, and it is thus necessary to operate the device at high frequency and to maintain safety by continuously cleaning the filter. However, in such an operation, there are concerns about an increase in the electricity cost of the entire system, a reduction in the life of the device due to high frequency use, and an increase in the running cost of the system due to an increase in the replacement cycle. Therefore, when a device capable of automatically removing dust is attached to an oxygen concentration measurement device, a determination method for reducing operating costs by operating the device when necessary is important.

As an index for efficiently determining the operation of the system, there is an index that pays attention to the relationship between humidity and the behavior of dust. It is generally known that the dust absorbs moisture in a high humidity environment and falls under its weight as shown in NPL 3. FIG. 14 is a graph showing a relationship between an average humidity and the amount of dust in a cable tunnel, showing the results of measuring how the amount of dust with a diameter of 10.0 μm changes depending on the humidity in the cable tunnel. Referring to FIG. 14, it can be seen that the amount of dust at a point where the average humidity is about 40% to 80% varies largely up to about 800, 000 pieces/m³ at the maximum, whereas at points where the average humidity exceeds 80%, the number of all dust particles is relatively small as about 100,000 pieces/m³ or less except for one sample. Therefore, it can be seen that there is a high probability that the amount of dust present will decrease high in a place where the state of high humidity continues to some extent. Accordingly, it is considered that, in a high humidity state, it is difficult for dust to adhere to the filter of the oxygen concentration measurement device, and when the dry state continues, the amount of dust increases and the probability of adhesion to the filter increases. Therefore, it is considered as an efficient operation method to operate the system at the timing when dust tends to adhere based on such determination criteria.

In this way, in consideration of the relationship between the humidity in the structure and dust, it has been desired to improve a technique for preventing malfunction of an oxygen concentration measurement device caused by contamination of a protective filter of the oxygen concentration measurement device.

An object of the present disclosure made in view of such circumstances is to improve a technique for preventing malfunction of an oxygen concentration measurement device caused by contamination of a protective filter of the oxygen concentration measurement device.

### Solution to Problem

A dust removal determination device according to the present disclosure includes: a measurement value acquisition part that acquires a plurality of measurement values at predetermined time intervals of humidity in a structure including an oxygen concentration measurement device; a decision part that decides whether or not the humidity is less than a reference value by using the measurement values; and a signal generation part that generates a signal instructing removal of dirt on the oxygen concentration measurement device according to the decision of the decision part.

A dust removal device according to the present disclosure is a dust removal device that communicates with the dust removal determination device according to the present disclosure, in which the oxygen concentration measurement device includes a filter part that prevents impurities from entering the oxygen concentration measurement device, and the dust removal device includes: a control unit that acquires a signal instructing removal of the dirt from the dust removal determination device; and a vibration unit that removes dust on the filter part by applying vibration to the filter part according to the acquired signal.

A dust removal determination method according to the present disclosure includes: an acquisition step of acquiring a plurality of measurement values at predetermined time intervals of humidity in a structure including an oxygen concentration measurement device; a decision step of deciding whether or not the humidity is less than a reference value by using the measurement values; and a generation step of generating a signal instructing removal of dirt on the oxygen concentration measurement device according to the decision in the decision step.

### Advantageous Effects of Invention

According to the present disclosure, it is possible to provide a technique for improving a technique for preventing malfunction of an oxygen concentration measurement device caused by contamination of a protective filter of the oxygen concentration measurement device.

### BRIEF DESCRIPTION OF DRAWINGS

FIG. 1 is a diagram for describing a system according to a first embodiment.

FIG. 2 is a diagram for describing a cable tunnel according to the present disclosure, and a humidity measurement device, a dust removal device, and an oxygen concentration measurement device provided in the cable tunnel.

FIG. 3 is a diagram illustrating an example of a configuration of a humidity measurement device according to the first embodiment.

FIG. 4 is a diagram illustrating an example of a configuration of a dust removal determination device according to the first embodiment.

FIG. 5 is a diagram for describing a dust removal device according to the first embodiment.

FIG. 6 is a diagram illustrating an operation of the system according to the first embodiment.

FIG. 7 is a diagram illustrating an operation of a system according to a second embodiment.

FIG. 8 is a diagram for describing a dust removal device according to Modification 1.

FIG. 9 is a diagram for describing a dust removal device according to Modification 2.

FIG. 10 is a diagram for describing a dust removal device according to Modification 3.

FIG. 11A is a diagram for describing a dust removal device according to Modification 4.

FIG. 11B is a diagram for describing the dust removal device according to Modification 4.

FIG. 12 is a diagram for describing a dust removal device according to Modification 5.

FIG. 13A is a diagram for describing a dust removal device according to Modification 6.

FIG. 13B is a diagram for describing the dust removal device according to Modification 6.

FIG. 14 is a diagram for describing a relationship between an average humidity and the amount of dust in a cable tunnel.

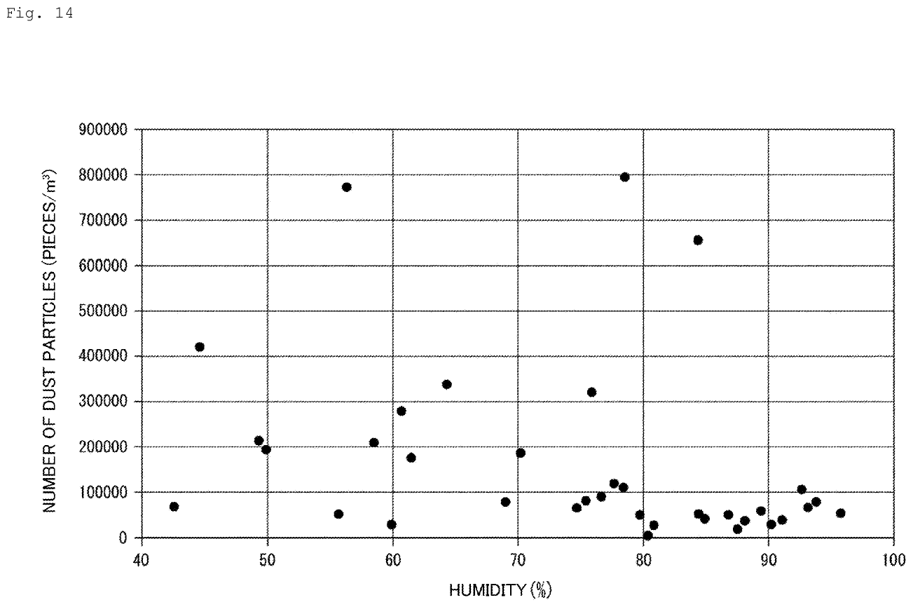

### DESCRIPTION OF EMBODIMENTS

### First Embodiment

Hereinafter, embodiments of the present disclosure will be described with reference to the drawings as appropriate. Note that “upward” and “downward” in the following description mean directions parallel to a Z axis of the coordinate axis display drawn in the drawings, and “horizontal” means directions parallel to an XY plane of the coordinate axis display drawn in the drawings. In the drawings, the same or corresponding parts are denoted by the same reference numerals. In the description of the present embodiment, description of the same or corresponding parts will be appropriately omitted or simplified. The embodiments described below are examples of a configuration of the present disclosure, and the present disclosure is not limited to the following embodiments.

### <Configuration of System 1>

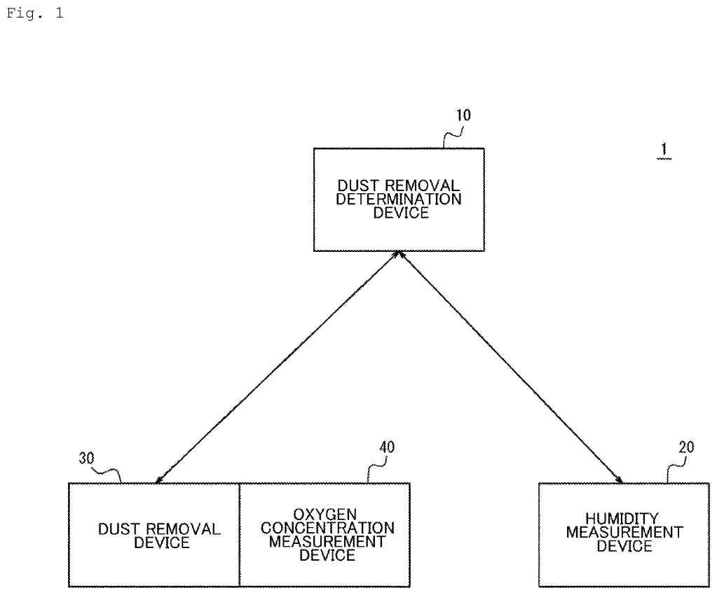

With reference to FIG. 1, an example of the configuration of a system 1 according to the present embodiment will be described. As illustrated in FIG. 1, the system 1 includes a dust removal determination device 10, a humidity measurement device 20, a dust removal device 30, and an oxygen concentration measurement device 40. The system 1 is a system capable of automatically removing impurities, such as dust, when the impurities adhere to and remain in a filter part serving as an air suction port of a zirconia type (limiting current type) oxygen concentration measurement device.

The dust removal determination device 10, the humidity measurement device 20, and the dust removal device 30 may be communicatively connected to each other by wire or wirelessly. There is no particular limitation on a communication method for transmitting/receiving of information between the devices. Moreover, each device may be constructed integrally.

The humidity measurement device 20 measures humidity in a structure. A structure means a cable tunnel in the present embodiment. A cable tunnel is an underground tunnel for laying a communication cable. Structures include, but are not limited to, for example, tunnels for laying gas pipes or power lines, or manholes.

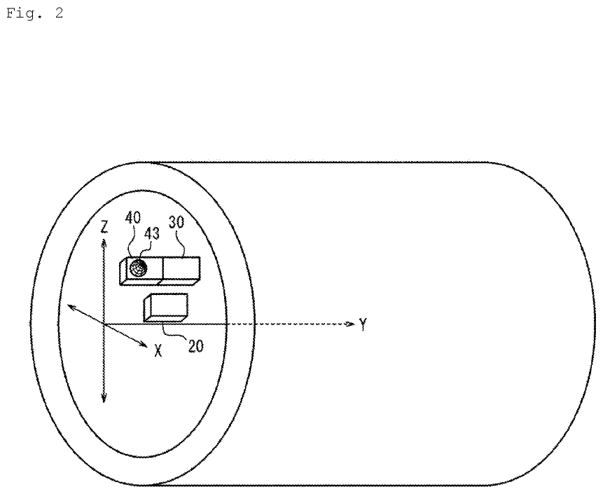

FIG. 2 is a simplified illustration of a cable tunnel. The height from the upper part to the lower part of the cable tunnel in a Z-axis direction and the width in an X-axis direction are, for example, about 3 meters. A Y-axis direction is the depth direction of the cable tunnel. The cable tunnel may have a rectangular cross-sectional shape other than a circular cross-sectional shape as illustrated in FIG. 2. People can enter the cable tunnel for work. The humidity measurement device 20 may be attached to the side wall surface of the cable tunnel as illustrated in FIG. 2. The humidity measurement device 20 is provided in the vicinity of the oxygen concentration measurement device 40. The vicinity is provided at a position within a radius of, for example, 1 meter of the oxygen concentration measurement device 40. As will be described below, the humidity measurement device 20 can transmit the measured humidity value to the dust removal determination device 10.

The dust removal device 30 may be integrally constituted by combining with the oxygen concentration measurement device 40, or may be added to an existing oxygen concentration measurement device 40. The dust removal device 30 may be attached to the side wall surface of the cable tunnel as illustrated in FIG. 2 in a state where the dust removal device 30 is combined with the oxygen concentration measurement device 40. As will be described below, the dust removal device 30 removes dust adhering to a filter part 43 of the oxygen concentration measurement device 40 in response to an instruction from the dust removal determination device 10.

The oxygen concentration measurement device 40 is, for example, a zirconia type oxygen concentration measurement device. Since the zirconia type oxygen concentration measurement device is already known, detailed description thereof will be omitted. The oxygen concentration measurement device 40 includes an oxygen concentration sensor 41 for measuring the oxygen concentration of air in the cable tunnel, a suction port 42 for taking the air into the oxygen concentration measurement device 40 and making the oxygen concentration sensor 41 react, and the filter part 43 provided in the suction port 42. The oxygen concentration measurement device 40 may be attached to the side wall surface of the cable tunnel as illustrated in FIG. 2 in a state where the oxygen concentration measurement device 40 is combined with the dust removal device 30.

The oxygen concentration measurement device 40 is provided in a structure such as a cable tunnel and measures the oxygen concentration in the structure. The oxygen concentration measurement device 40 is positioned at the height of 1 m above the ground, for example. In the present embodiment, the oxygen concentration sensor 41 is provided on the side part of the oxygen concentration measurement device 40, and the filter part 43 protrudes from the outer side surface of the oxygen concentration measurement device 40 into the cable tunnel in the X-axis direction. Without being limited to this, the oxygen concentration sensor 41 may be provided on the upper part of the oxygen concentration measurement device 40, and the filter part 43 may protrude from the outer upper surface of the oxygen concentration measurement device 40 into the cable tunnel in the Z-axis direction.

The filter part 43 prevents impurities such as water and dust from entering the oxygen concentration measurement device 40. Thus, it is possible to prevent the oxygen concentration sensor 41 from being deteriorated due to contact of impurities with the oxygen concentration sensor 41 in the oxygen concentration measurement device 40. The filter part 43 may be made of metal, for example. Although the filter part 43 has a circular dome-like bottom surface in the present embodiment, the filter part 43 is not limited to this, but may have a rectangular column-like bottom surface.

The dust removal determination device 10 may be provided in a structure or in an external facility managing the structure. The dust removal determination device 10 acquires a measurement value of humidity in the cable tunnel measured by the humidity measurement device 20, and decides whether or not the humidity is less than a reference value by using the measurement value. The dust removal determination device 10 generates a signal instructing removal of dirt on the oxygen concentration measurement device 40 according to the decision, and transmits the signal to the dust removal device 30.

In response to a signal from the dust removal determination device 10, the dust removal device 30 removes dirt from the oxygen concentration measurement device 40, as will be described below. More specifically, the dust adhering to the filter part 43 is removed by applying vibration to the filter part 43 of the oxygen concentration measurement device 40. Thus, the malfunction of the oxygen concentration measurement device 40 is prevented, and the oxygen concentration can be measured at all times. The oxygen concentration measurement device 40 always operates normally, and thereby safe and continuous work in the structure can be implemented.

### <Configuration of Humidity Measurement Device 20>

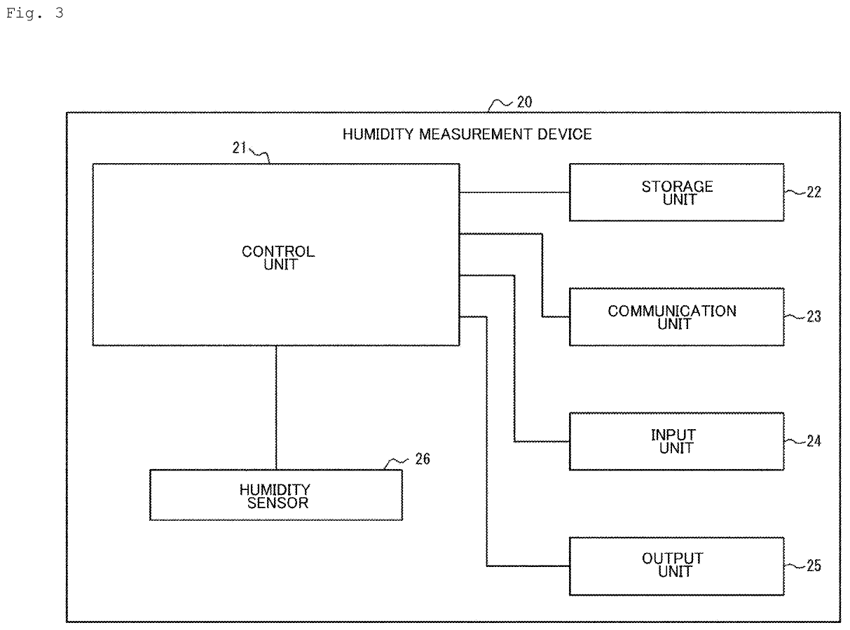

With reference to FIG. 3, an example of the configuration of the humidity measurement device 20 according to the present embodiment will be described. As illustrated in FIG. 3, the humidity measurement device 20 includes a control unit 21, a storage unit 22, a communication unit 23, an input unit 24, an output unit 25, and a humidity sensor 26.

The storage unit 22 includes one or more memories and may include, for example, a semiconductor memory, a magnetic memory, an optical memory, and the like. Each of the memories included in the storage unit 22 may function, for example, as a main storage device, an auxiliary storage device, or a cache memory. The storage unit 22 stores arbitrary information used for the operation of the humidity measurement device 20. The storage unit 22 does not necessarily have to be provided inside the humidity measurement device 20, and may be provided outside the humidity measurement device 20.

The communication unit 23 includes at least one communication interface. The communication interface is, for example, a LAN interface. The communication unit 23 receives information used for the operation of the humidity measurement device 20, and transmits information obtained by the operation of the humidity measurement device 20.

The communication unit 23 allows the humidity measurement device 20 to transmit and receive information to and from other devices via a network. The network includes the Internet, at least one wide area network (WAN), at least one metropolitan area network (MAN), or a combination thereof. The network may include at least one wireless network, at least one optical network, or a combination thereof. The wireless network is, for example, an ad hoc network, a cellular network, a wireless local area network (LAN), a satellite communication network, or a terrestrial microwave network.

The input unit 24 includes at least one input interface. The input interface is, for example, a physical key, a capacitance key, a pointing device, a touch screen provided integrally with a display, or a microphone. The input unit 24 receives an operation for inputting information used for the operation of the humidity measurement device 20. The input unit 24 may be connected to the humidity measurement device 20 as an external input device instead of being provided in the humidity measurement device 20. As the connection method, for example, any method such as Universal Serial Bus (USB), High-Definition Multimedia Interface (HDMI) (registered trademark), or Bluetooth (registered trademark) can be used.

The output unit 25 includes at least one output interface. The output interface is, for example, a display or a speaker. The display is, for example, a liquid crystal display (LCD) or an organic electro luminescence (EL) display. The output unit 25 outputs information obtained by the operation of the humidity measurement device 20. The output unit 25 may be connected to the humidity measurement device 20 as an external output device instead of being provided in the humidity measurement device 20. As the connection method, for example, any method such as USB, HDMI (registered trademark), or Bluetooth (registered trademark) can be used.

The humidity sensor 26 is composed of an absolute hygrometer or a relative hygrometer. The humidity sensor 26 can measure a humidity value xᵢ of the air in the cable tunnel n times every t seconds. Here, t and n are presettable values, and the value of t is, for example, 60 seconds. Since air circulates at about 0.3 m/s wind velocity in the cable tunnel, the humidity value in a certain space near the humidity measurement device 20, that is, near the oxygen concentration measurement device 40, can be ascertained by setting t so that the air around the humidity sensor 26 is completely replaced. The humidity sensor 26 outputs the humidity value measured n times every t seconds to the control unit 21 as a measurement value.

The control unit 21 is implemented by a control arithmetic circuit (controller). The control arithmetic circuit may be configured by dedicated hardware such as an application specific integrated circuit (ASIC) or a field-programmable gate array (FPGA), or may be configured by a processor, or may be configured by including both. The control unit 21 executes processing related to the operation of the humidity measurement device 20 while controlling each unit of the humidity measurement device 20. The control unit 21 can transmit and receive information to and from an external device via the communication unit 23 and a network.

The control unit 21 transmits information indicating the measurement value output by the humidity sensor 26 to the dust removal determination device 10 via the communication unit 23. The transmission of the information indicating the measurement value may be performed at all times.

### <Configuration of Dust Removal Determination Device 10>

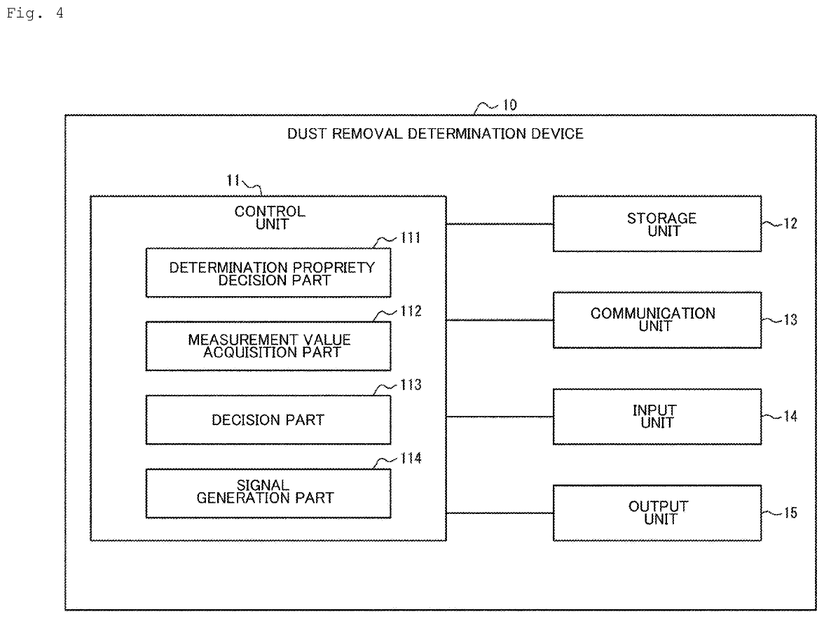

With reference to FIG. 4, an example of the configuration of the dust removal determination device 10 according to the present embodiment will be described. As illustrated in FIG. 4, the dust removal determination device 10 includes a control unit 11, a storage unit 12, a communication unit 13, an input unit 14, and an output unit 15.

The storage unit 12 includes one or more memories and may include, for example, a semiconductor memory, a magnetic memory, an optical memory, and the like. Each of the memories included in the storage unit 12 may function, for example, as a main storage device, an auxiliary storage device, or a cache memory. The storage unit 12 stores arbitrary information used for the operation of the dust removal determination device 10. The storage unit 12 does not necessarily have to be provided inside the dust removal determination device 10, and may be provided outside the dust removal determination device 10.

The communication unit 13 includes at least one communication interface. The communication interface is, for example, a LAN interface. The communication unit 13 receives information used for the operation of the dust removal determination device 10, and transmits information obtained by the operation of the dust removal determination device 10.

The communication unit 13 enables the dust removal determination device 10 to transmit and receive information to and from other devices via a network. The network includes the Internet, at least one WAN, at least one MAN, or a combination thereof. The network may include at least one wireless network, at least one optical network, or a combination thereof. The wireless network may include, for example, an ad hoc network, a cellular network, a wireless LAN, a satellite communication network, or a terrestrial microwave network.

The input unit 14 includes at least one input interface. The input interface is, for example, a physical key, a capacitance key, a pointing device, a touch screen provided integrally with a display, or a microphone. The input unit 14 receives an operation for inputting information used for the operation of the dust removal determination device 10. The input unit 14 may be connected to the dust removal determination device 10 as an external input device instead of being provided in the dust removal determination device 10. As the connection method, for example, any method such as USB, HDMI (registered trademark), or Bluetooth (registered trademark) can be used.

The output unit 15 includes at least one output interface. The output interface is, for example, a display or a speaker. The display is, for example, an LCD or an organic EL display. The output unit 15 outputs information obtained by the operation of the dust removal determination device 10. The output unit 15 may be connected to the dust removal determination device 10 as an external output device instead of being provided in the dust removal determination device 10. As the connection method, for example, any method such as USB, HDMI (registered trademark), or Bluetooth (registered trademark) can be used.

The control unit 11 is implemented by a control arithmetic circuit (controller). The control arithmetic circuit may be configured by dedicated hardware such as an ASIC or an FPGA, or may be configured by a processor, or may be configured by including both. The control unit 11 executes processing related to the operation of the dust removal determination device 10 while controlling each unit of the dust removal determination device 10. The control unit 11 can transmit and receive information to and from an external device via the communication unit 13 and a network. The control unit 11 receives information indicating a measurement value of humidity from the humidity measurement device 20 via the communication unit 13.

The control unit 11 includes a determination propriety decision part 111, a measurement value acquisition part 112, a decision part 113, and a signal generation part 114.

The determination propriety decision part 111 acquires a measurement value of humidity in the structure as an initial humidity value xᵢ, and calculates a standard deviation value S of the initial humidity value xᵢ. In the present embodiment, the structure is a cable tunnel. Specifically, the determination propriety decision part 111 acquires a measurement value measured n times every t seconds by the humidity measurement device 20 as an initial humidity value xᵢ. The determination propriety decision part 111 obtains a standard deviation value S of the acquired initial humidity value xᵢ using the following Equation (1).

$$\begin{matrix}[ Math . 1 ] & \\ S = \sqrt{\frac{1}{n} {\sum }_{i = 1}^{n} {( {x}_{i} - \overline{x} )}^{2}} & ( 1 )\end{matrix}$$

Here, n is the number of times the humidity is measured, and may be arbitrarily set. x bar is an average value of the initial humidity values xᵢ measured n times. From the equation, the determination propriety decision part 111 can calculate a standard deviation value S of the acquired initial humidity value xᵢ.

The determination propriety decision part 111 determines whether or not the value of the standard deviation value S is less than a predetermined value α set in advance. The value of a may be set arbitrarily. When the value of the standard deviation value S is less than the predetermined value a, it can be determined that the acquired initial humidity value xᵢ does not vary and the humidity is measured correctly. Therefore, the determination propriety decision part 111 determines that the environment in the structure is suitable for dust removal determination. In this case, the operation of the dust removal determination device 10 proceeds to processing by the measurement value acquisition part 112 next. On the other hand, when the value of the standard deviation value S is equal to or greater than the predetermined value α, it can be determined that the initial humidity value xᵢ varies and the humidity is not measured correctly. That is, the determination propriety decision part 111 can determine that the environment in the cable tunnel is not suitable for dust removal determination. In this case, the control unit 11 receives information indicating the measurement value of humidity again from the humidity measurement device 20.

The determination propriety decision part 111 may notify a user of information indicating that the environment in the structure is determined not to be suitable for dust removal determination and the reason. The output may be directly performed to the user via the output unit 15, or the information may be transmitted to a terminal device owned by the user via the communication unit 13, and the terminal device receiving the information may be notified to the user by an image, voice, or the like.

As an example of the reason why it is determined that the situation is not suitable for dust removal determination, the following reasons are given.

First, there is a case where the humidity measurement device 20 is in failure. In this case, the determination propriety decision part 111 may notify the user of information for urging the user to repair the humidity measurement device 20. The detection of the failure of the humidity measurement device 20 may be performed by an arbitrary method, and may be performed by the dust removal determination device 10 receiving information indicating the operation state of the humidity measurement device 20 from the humidity measurement device 20 via the communication unit 13, for example.

Another reason is that the ventilation device is operated to ventilate the inside of the cable tunnel. In this case, the determination propriety decision part 111 may detect that the ventilation device is stopped, acquire the initial humidity value xᵢ again after a predetermined time has passed until the air in the cable tunnel returns to a steady state, and calculate the standard deviation value S. The detection of the operation and stop of the ventilation device may be performed by an arbitrary method, and may be performed by the dust removal determination device 10 receiving information indicating the operation state of the ventilation device from the ventilation device via the communication unit 13, for example.

Another reason is that the air in the cable tunnel is not in a steady state. This is because, for example, an operator performs work such as construction in the vicinity of the humidity measurement device 20, and therefore the air flow is changed. In this case, there is a likelihood that the dust may fly into the space due to the movement of the operator. Therefore, the determination propriety decision part 111 may detect that the work such as construction has been completed, and then perform the processing of the signal generation part 114 to be described below. The detection of the completion of the work may be performed by an arbitrary method, and may be performed by receiving the input of the operator via the input unit 14, for example.

The measurement value acquisition part 112 acquires a plurality of measurement values yᵢ at predetermined time intervals of humidity in a structure including the oxygen concentration measurement device 40. In the present embodiment, the structure is a cable tunnel. The predetermined time is, for example, 60 seconds, but is not limited to this and may be set arbitrarily. The measurement value acquisition part 112 may acquire the initial humidity value xᵢ acquired by the determination propriety decision part 111 as a part or all of the measurement value yᵢ. The measurement value acquisition part 112 outputs the plurality of acquired measurement values yᵢ to the decision part 113.

The decision part 113 decides whether or not the humidity is less than a reference value β by using the measurement value yᵢ. Specifically, the decision part calculates an average value P of the plurality of acquired measurement values yᵢ, and decides whether or not the average value P is less than the reference value β. The reference value β may be arbitrarily set, and is, for example, a value of 80%.

More specifically, when the number of times of acquisitions of the measurement value yᵢ becomes k times or more, the decision part 113 uses measurement values yₖ₋ₐ to yₖ from the k-a-th time to the k-th time to calculate an average value P_{k-a,k} according to the following Equation (2).

$$\begin{matrix}[ Math . 2 ] & \\ {P}_{k - a , k} = \frac{{y}_{k - α} + {y}_{k - a + 1} + … {y}_{k}}{a + 1} & ( 2 )\end{matrix}$$

Here, k is an integer of 2 or more. a is an integer value of 1 or more, and k>a. a is a value which can be arbitrarily set as the number of sampling times. According to Equation (2), for example, when the value of a is set to 4 as the number of sampling times, the average value from the measurement value yₖ₋₄ four times before the k-th time to the k-th measurement value yₖ is calculated.

Next, the decision part 113 decides whether or not the calculated average value P_{k-a,k} is less than the reference value β. When the average value is less than the reference value β, the operation of the dust removal determination device 10 proceeds to processing by the signal generation part 114 next. When the average value is equal to or greater than the reference value β, the decision part 113 increases the value of k up to the maximum number of trials m. Thereafter, the measurement value acquisition part 112 acquires the measurement value yᵢ again, and the decision part 113 calculates the average value P_{k-a,k} of the measurement value yᵢ again, and decides whether or not the average value P_{k-a,k} is less than the reference value β. The value of the maximum number of trials m is, for example, when a ventilation time in the cable tunnel is planned in advance, the value of the maximum number of times at which the humidity measurement device 20 can measure the value of the humidity by the ventilation time.

For example, it is assumed that the measurement value acquisition part 112 sequentially acquires values of 74%, 81%, 76%, 80%, and 79% as the measurement values yᵢ and outputs the acquired values to the decision part 113. Further, it is assumed that the value of k is set to 5 and the value of a is set to 4, respectively. It is also assumed that the reference value β is 80%.

In this case, first, when the number of times of acquisitions of the measurement value yᵢ becomes five, the decision part 113 calculates an average from the value of 74% which is the measurement value y₅₋₄ four times before the fifth time to the value of 79% which is the measurement value y₅ of the fifth time. In this example, according to the above Equation (2), (74+81+76+80+79)/5=78. Thus, the decision part 113 calculates a value of 78% humidity as the average values P_{5-4,5}. Since the value is less than 80% of the reference value β, the decision part 113 decides that the calculated average value P_{5-4,5} is less than the reference value β. Then, the operation of the dust removal determination device 10 proceeds to processing by the signal generation part 114 next.

In this way, the decision part 113 decides whether or not the humidity is less than the reference value β by using the measurement value yᵢ.

The signal generation part 114 generates a signal instructing removal of dirt on the oxygen concentration measurement device 40 according to the decision of the decision part 113. In the present embodiment, when the decision part 113 decides that the calculated average value P_{k-a,k} is less than the reference value β, a signal instructing removal of dirt on the oxygen concentration measurement device 40 is generated. The signal generation part 114 outputs the generated signal to the control unit 11.

The control unit 11 transmits the signal generated by the signal generation part 114 to the dust removal device 30 via the communication unit 13.

### <Configuration of Dust Removal Device 30>

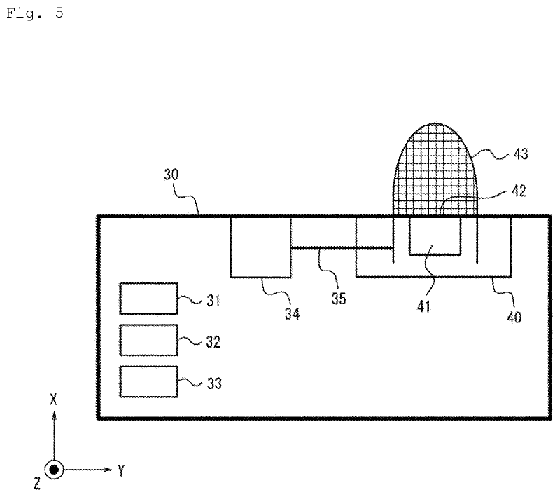

Next, an example of the configuration of the dust removal device 30 according to the present embodiment will be described with reference to FIG. 5. As illustrated in FIG. 5, in the present embodiment, the dust removal device 30 is combined with an oxygen concentration measurement device 40 to be integrally constructed. The dust removal device 30 includes a control unit 31, a storage unit 32, a communication unit 33, a vibration unit 34, and a vibration propagation unit 35.

The storage unit 32 includes one or more memories and may include, for example, a semiconductor memory, a magnetic memory, an optical memory, and the like. Each of the memories included in the storage unit 32 may function, for example, as a main storage device, an auxiliary storage device, or a cache memory. The storage unit 32 stores arbitrary information used for the operation of the dust removal device 30. The storage unit 32 does not necessarily have to be provided inside the dust removal device 30, and may be provided outside the dust removal device 30.

The communication unit 33 includes at least one communication interface. The communication interface is, for example, a LAN interface. The communication unit 33 receives information used for the operation of the dust removal device 30, and transmits information obtained by the operation of the dust removal device 30.

The communication unit 33 enables the dust removal device 30 to transmit and receive information to and from other devices via a network. The network includes the Internet, at least one WAN, at least one MAN, or a combination thereof. The network may include at least one wireless network, at least one optical network, or a combination thereof. The wireless network may include, for example, an ad hoc network, a cellular network, a wireless LAN, a satellite communication network, or a terrestrial microwave network.

The control unit 31 is implemented by a control arithmetic circuit (controller). The control arithmetic circuit may be configured by dedicated hardware such as an ASIC or an FPGA, or may be configured by a processor, or may be configured by including both. The control unit 31 executes processing related to the operation of the dust removal device 30 while controlling each unit of the dust removal device 30. The control unit 31 can transmit and receive information to and from an external device via the communication unit 33 and a network. The control unit 31 acquires the signal instructing removal of dirt from the dust removal determination device 10. The acquisition of the signal may be performed by receiving the signal via the communication unit 33. Upon acquiring the signal, the control unit 31 controls the vibration unit 34 to generate vibration.

The vibration unit 34 has a drive part and a weight member attached to a shaft part of the drive part and rotating together with the shaft part. When the drive part is driven, the weight member rotates eccentrically, and vibration is generated.

The vibration propagation unit 35 protrudes from the dust removal device 30, connects the vibration unit 34 and the filter part 43 of the oxygen concentration measurement device 40, and propagates the vibration generated by the vibration unit 34 to the oxygen concentration measurement device 40. Thus, the filter part 43 vibrates, the dust adhering to the filter part 43 falls off, and dirt on the oxygen concentration measurement device 40 is removed. The material of the vibration propagation unit 35 is not limited, but it is desirable that the material does not attenuate the vibration from the vibration unit 34.

Although the position where the vibration unit 34 and the vibration propagation unit 35 are provided is not particularly limited, it is desirable to provide the vibration unit 34 and the vibration propagation unit 35 inside the dust removal device 30 as illustrated in FIG. 5. Thus, deterioration of the vibration unit 34 and the vibration propagation unit 35 due to environmental factors such as high humidity can be prevented.

### <Program>

It is also possible to use a computer capable of executing program instructions in order to function as the dust removal determination device 10 or the dust removal device 30 described above. Here, the computer may be a general-purpose computer, a dedicated computer, a workstation, a personal computer (PC), an electronic notepad, or the like. The program instruction may be a program code, a code segment, or the like for executing required tasks.

The computer includes a processor, a storage unit, an input unit, an output unit, and a communication interface. The processor is a central processing unit (CPU), a micro processing unit (MPU), a graphics processing unit (GPU), a digital signal processor (DSP), or a system on a chip (SoC), and may be configured by a plurality of processors of the same type or different types. The processor reads a program from the storage unit and executes the read program, thereby controlling each of the configurations described above and performing various arithmetic operations. At least a part of these processing contents may be implemented by hardware. The input unit is an input interface for receiving an input operation of a user and acquiring information based on an operation of the user, and is a pointing device, a keyboard, a mouse, or the like. The output unit is an output interface for outputting information, and is a display, a speaker, or the like. The communication interface is an interface for communication with an external device.

The program may also be recorded on a computer-readable recording medium. Using such a recording medium, it is possible to install the program on the computer. Here, the recording medium on which the program is recorded may be a non-transitory recording medium. Although not particularly limited, the non-transitory recording medium may be, for example, a CD-ROM, a DVD-ROM, a USB memory, or the like. Also, the program may be downloaded from an external device via a network.

### <Operation of System 1>

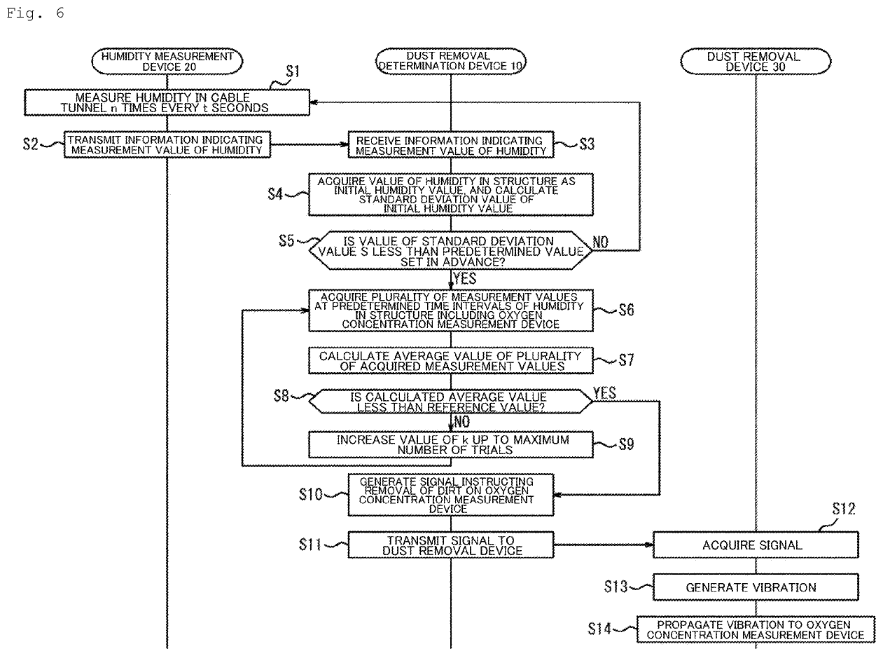

Next, the operation of the system 1 including the dust removal determination device 10 and the dust removal device 30 according to the present embodiment will be described with reference to FIG. 6. Among the operations of the system 1, the operation of the dust removal determination device 10 corresponds to the dust removal determination method according to the present embodiment.

In step S1, the humidity sensor 26 of the humidity measurement device 20 measures the humidity in the cable tunnel n times every t seconds.

In step S2, the control unit 21 of the humidity measurement device 20 transmits information indicating the measurement value of humidity to the dust removal determination device 10 via the communication unit 23.

In step S3, the control unit 11 of the dust removal determination device 10 receives information indicating the measurement value of humidity from the humidity measurement device 20 via the communication unit 13.

In step S4, the determination propriety decision part 111 acquires a value of humidity in the structure as an initial humidity value xᵢ, and calculates a standard deviation value S of the initial humidity value xᵢ. In the present embodiment, the structure is a cable tunnel. Specifically, the determination propriety decision part 111 acquires a measurement value measured n times every t seconds by the humidity measurement device 20 as an initial humidity value xᵢ. The determination propriety decision part 111 obtains a standard deviation value S of the acquired initial humidity value xᵢ using the above Equation (1).

In step S5, the determination propriety decision part 111 determines whether or not the value of the standard deviation value S is less than a predetermined value α set in advance. The predetermined value α may be set arbitrarily. When the value of the standard deviation value S is less than the predetermined value α, it can be determined that the acquired initial humidity value xᵢ does not vary and the humidity is measured correctly. Therefore, the determination propriety decision part 111 determines that the environment in the structure is suitable for dust removal determination. In this case, the operation of the system 1 proceeds to step S6. On the other hand, when the value of the standard deviation value S is equal to or greater than the predetermined value α, it can be determined that the initial humidity value xᵢ varies and the humidity is not measured correctly. That is, the determination propriety decision part 111 can determine that the environment in the cable tunnel is not suitable for dust removal determination. In this case, the operation of the system 1 returns to step S1.

The determination propriety decision part 111 may notify a user of information indicating that the environment in the structure is determined not to be suitable for dust removal determination and the reason. The notification may be directly performed to the user via the output unit 25, or the information may be transmitted to a terminal device owned by the user via the communication unit 13, and the terminal device receiving the information may be notified to the user by an image, voice, or the like.

In step S6, the measurement value acquisition part 112 acquires a plurality of measurement values yᵢ at predetermined time intervals of humidity in a structure including the oxygen concentration measurement device 40. In the present embodiment, the structure is a cable tunnel. The predetermined time is, for example, 60 seconds, but is not limited to this and may be set arbitrarily. The measurement value acquisition part 112 may acquire the initial humidity value xᵢ acquired by the determination propriety decision part 111 as a part or all of the measurement value yᵢ. The measurement value acquisition part 112 outputs the plurality of acquired measurement values yᵢ to the decision part 113.

In step S7, the decision part 113 calculates an average value P of the plurality of acquired measurement values yᵢ.

Specifically, when the number of times of acquisitions of the measurement value yᵢ becomes k times or more, the decision part 113 uses measurement values yₖ₋ₐ to yₖ from the k-a-th time to the k-th time to calculate an average value P_{k-a,k} according to the above Equation (2).

In step S8, the decision part 113 decides whether or not the calculated average value P_{k-a,k} is less than the reference value β. The reference value β may be arbitrarily set, and is, for example, a value of 80%. When the average value is equal to or greater than the reference value β, the operation of the dust removal determination device 10 proceeds to step S9. When the average value is less than the reference value β, the operation of the dust removal determination device 10 proceeds to step S10.

As shown in step S7 and step S8, the decision part 113 calculates an average value P of the plurality of acquired measurement values yᵢ, and decides whether or not the average value P is less than the reference value β. In this way, the decision part 113 decides whether or not the humidity is less than the reference value β by using the measurement value yᵢ.

First, the case where it is determined that the calculated average value P_{k-a,k} is equal to or greater than the reference value β in step S8 and the operation of the dust removal determination device 10 proceeds to step S9 will be described. In step S9, the decision part 113 increases the value of k up to the maximum number of trials m. Thereafter, the operation of the dust removal determination device 10 returns to step S6.

Subsequently, the case where it is determined that the calculated average value P_{k-a,k} is less than the reference value β in step S8 and the operation of the dust removal determination device 10 proceeds to step S10 will be described. In step S10, the signal generation part 114 generates a signal instructing removal of dirt on the oxygen concentration measurement device 40. In this way, the signal generation part 114 generates a signal instructing removal of dirt on the oxygen concentration measurement device 40 according to the decision of the decision part 113. The signal generation part 114 outputs the generated signal to the control unit 11.

In step S11, the control unit 11 transmits the signal generated by the signal generation part 114 to the dust removal device 30 via the communication unit 13.

In step S12, the control unit 31 of the dust removal device 30 acquires the signal instructing removal of dirt from the dust removal determination device 10. In this example, the control unit 31 acquires the signal by receiving the signal via the communication unit 33.

In step S13, the control unit 31 controls the vibration unit 34 to generate vibration.

In step S14, the vibration propagation unit 35 propagates the vibration generated by the vibration unit 34 to the oxygen concentration measurement device 40. Specifically, the vibration propagation unit 35 propagates vibration to the filter part 43 provided in the oxygen concentration measurement device 40. Thus, the filter part 43 vibrates, the dust adhering to the filter part 43 falls off, and dirt on the oxygen concentration measurement device 40 is removed. Thereafter, the operation of the system 1 ends.

As described above, the dust removal determination device 10 according to the present embodiment includes: the measurement value acquisition part 112 that acquires a plurality of measurement values at predetermined time intervals of humidity in a structure including the oxygen concentration measurement device 40; the decision part 113 that decides whether or not the humidity is less than a reference value by using the measurement values; and the signal generation part 114 that generates a signal instructing removal of dirt on the oxygen concentration measurement device 40 according to the decision of the decision part 113.

According to the present embodiment, a threshold value for dividing high humidity and low humidity is set as a reference value, and the reference value can be compared to a plurality of measurement values of humidity. As a result of the comparison, when the measurement value is less than the reference value, there is a high likelihood that the dust will fly in the space of the structure such as a cable tunnel, and therefore the removal of the dirt on the oxygen concentration measurement device 40 can be started by the dust removal device 30. Thus, the dust removal device 30 can be operated only when the oxygen concentration measurement device 40 is soiled, that is, only when there is a high likelihood that dust has adhered to the filter part 43 of the oxygen concentration measurement device 40. Accordingly, compared to the case where the oxygen concentration measurement device 40 is cleaned at high frequency, it is possible to suppress an increase in the electricity cost of the entire system, a reduction in the life of the dust removal device 30 due to high frequency use, and an increase in the replacement cycle. As described above, according to the present embodiment, it is possible to improve a technique for preventing malfunction of the oxygen concentration measurement device 40 caused by contamination.

As described above, in the dust removal determination device 10 according to the present embodiment, the decision part 113 calculates the average value of the plurality of acquired measurement values, and decides whether or not the average value is less than the reference value.

According to the present embodiment, it can be ascertained that a state in which the average value of the measurement values from the k-a-th time to the k-th time is less than the reference value β, that is, the dry state continues for a certain period of time, among the measurement values related to the m-th measurement. When the dry state continues for a certain period of time, there is a higher likelihood that the dust will fly in the space of the structure such as a cable tunnel, and therefore the removal of the dirt on the oxygen concentration measurement device 40 can be started by the dust removal device 30. Thus, the dust removal device 30 can be operated only when there is a high likelihood that dust has adhered to the filter part 43 of the oxygen concentration measurement device 40. Accordingly, compared to the case where the dust removal device 30 is operated at high frequency, it is possible to suppress an increase in the electricity cost of the entire system, a reduction in the life of the dust removal device 30 due to high frequency use, and an increase in the replacement cycle.

Also, according to the present embodiment, even when the humidity environment in the cable tunnel is suddenly changed and a high humidity state and a low humidity state are switched by work and ventilation in the cable tunnel, continuation of the dry state is accurately ascertained and the dust removal device 30 can be operated. For example, a method is assumed in which the value of a is not set as the number of sampling times as described above, and a signal is transmitted to the dust removal device 30 to operate the dust removal device 30 when the measurement value yᵢ less than the reference value β is simply continued three times. It is assumed that the reference value β is set to a value of 80%, and the measurement value acquisition part 112 acquires the measurement values yᵢ in the order of 75%, 75%, 95%, 75%, and 75%. In this case, according to the present embodiment, 75+75+95+75+75/5=79, and the decision part 113 calculates an average value P of 79%, and can start the operation of the dust removal device 30. On the other hand, in the method according to this example, since the measurement value yᵢ less than the reference value β is not continued three times, the operation of the dust removal device 30 cannot be started. In this way, in the method according to this example, an event occurs that the dust removal device 30 is not started regardless of a state in which four of the five measurement values yᵢ are less than the reference value β, that is, a substantially dry state.

In this way, according to the present embodiment, by setting the value of a as the number of sampling times for a certain period of time and calculating the average value P during the period, even if an event occurs in which a high humidity state and a low humidity state are primarily switched, it is possible to weaken the effect and express the humidity tendency in the cable tunnel. Thus, it is possible to improve a technique for preventing malfunction of the oxygen concentration measurement device 40 caused by contamination.

As described above, the dust removal determination device 10 according to the present embodiment further includes the determination propriety decision part that acquires a humidity value in the structure as an initial humidity value, calculates a standard deviation value of the initial humidity value, and decides determination propriety as to whether to remove dirt on the basis of whether or not the standard deviation value is less than a predetermined value.

According to the present embodiment, the determination propriety decision part 111 can decide whether or not the measurement values vary before the decision part 113 compares the measurement values with the reference values. When the measurement values vary, the reason why the oxygen concentration sensor 41 of the oxygen concentration measurement device 40 fails is assumed, as described above. Thus, before deciding whether to actually operate the dust removal device 30, the determination propriety decision part 111 can decide whether or not the environment in the cable tunnel is suitable for the measurement of humidity and the determination. Thus, the decision part 113 can be prevented from making an erroneous decision, and the operation cost of the dust removal determination device 10 and the dust removal device 30 can be reduced. Thus, it is possible to improve a technique for preventing malfunction of the oxygen concentration measurement device 40 caused by contamination.

As described above, the dust removal device 30 according to the present embodiment is a dust removal device that communicates with the dust removal determination device 10 according to the present embodiment, in which the oxygen concentration measurement device 40 includes the filter part 43 that prevents impurities from entering the oxygen concentration measurement device 40, and the dust removal device 30 includes: the control unit 31 that acquires a signal instructing removal of the dirt from the dust removal determination device 10; and the vibration unit 34 that removes dust on the filter part 43 by applying vibration to the filter part 43 according to the acquired signal.

According to the present embodiment, the dust removal device 30 can remove the dirt on the oxygen concentration measurement device 40 according to the decision of the dust removal determination device 10. The dust adhering to the filter part 43 of the oxygen concentration measurement device 40 can be automatically and effectively removed by the vibration unit 34 and the vibration propagation unit 35 of the dust removal device 30. According to the present embodiment, it is possible to reduce the labor and cost of manually removing the dirt by the operator. Further, compared to the case where the dust removal device 30 is operated at high frequency, it is possible to suppress an increase in the electricity cost of the entire system, a reduction in the life of the dust removal device 30 due to high frequency use, and an increase in the replacement cycle. Thus, it is possible to improve a technique for preventing malfunction of the oxygen concentration measurement device 40 caused by contamination.

### Second Embodiment

Differences between the first embodiment and the present embodiment will be described below.

Since the configuration of the system 1 according to the present embodiment is the same as that of the first embodiment illustrated in FIG. 1, the description thereof will be omitted. Also, since the configurations of the humidity measurement device 20, the dust removal device 30, and the oxygen concentration measurement device 40 according to the present embodiment are the same as those of the first embodiment, the description thereof will be omitted.

Since the parts other than the measurement value acquisition part 112 and the decision part 113 of the dust removal determination device 10 according to the present embodiment are the same as those of the first embodiment, the description thereof will be omitted.

The decision part 113 of the dust removal determination device 10 according to the present embodiment decides whether or not the humidity is less than the reference value β by using the measurement value yᵢ. Specifically, the decision part decides whether or not each of the plurality of acquired measurement values yᵢ is less than a reference value β, calculates a percentage value Q of the measurement values yᵢ that are less than the reference value β, and decides whether or not the percentage value Q is equal to or greater than a reference percentage value γ. The reference value β may be arbitrarily set, and is, for example, a value of 80%. The reference percentage value γ may be arbitrarily set, and is, for example, a value of 50%.

More specifically, when the number of times of acquisitions of the measurement value yᵢ becomes k times or more, the decision part 113 uses measurement values yᵢ from the k-a-th time to the k-th time to calculate a percentage value Q_{k-a,k} according to the following Equations (3) and (4).

$$\begin{matrix}[ Math . 3 ] & \\ {Q}_{k - a , k} = \frac{{\sum }_{i = k - a}^{k} {w}_{i}}{a + 1} & ( 3 )\end{matrix}$$

$$\begin{matrix}[ Math . 4 ] & \\ {w}_{i} = \{ \begin{matrix}1 , {y}_{i} < b \\ 0 , {y}_{i} \geq b\end{matrix} & ( 4 )\end{matrix}$$

Here, k is an integer of 2 or more. a is an integer value of 1 or more, and k>a. a is a value that can be arbitrarily set as the number of sampling times. Wᵢ is a binary variable indicating whether or not the measurement value yᵢ is less than the reference value β. When the measurement value yᵢ is less than the reference value β, 1 is input, and when the measurement value yᵢ is equal to or greater than the reference value β, 0 is input. According to Equations (3) and (4), for example, when the value of a is set to 4 as the number of sampling times, it is decided whether or not each of the measurement values yₖ₋₄ four times before the k-th time to the k-th measurement value yₖ is less than the reference value β, and a percentage of the measurement values yᵢ that are less than the reference value β is calculated.

Next, the decision part 113 decides whether or not the percentage value Q_{K-a,k} of the measurement values yᵢ that are less than the reference value β is equal to or greater than the reference percentage value γ. When the percentage value is equal to or greater than the reference percentage value γ, the operation of the dust removal determination device 10 proceeds to processing by the signal generation part 114 next.

When the percentage value is less than the reference percentage value γ, the decision part 113 increases the value of k up to the maximum number of trials m. Then, the measurement value acquisition part 112 acquires the measurement value yᵢ again, and the decision part 113 again decides whether or not each of the measurement values yₖ₋ₐ a times before the k-th time to the k-th measurement value yₖ is less than the reference value β, calculates the percentage value Q of the measurement values yᵢ that are less than the reference value β, and decides whether or not the percentage value is equal to or greater than the reference percentage value γ. The value of the maximum number of trials m is, for example, when the ventilation time in the cable tunnel is planned in advance, the value of the maximum number of times which can be measured from the start of measurement of the humidity value by the humidity measurement device 20 to the ventilation time.

For example, it is assumed that the measurement value acquisition part 112 sequentially acquires values of 95%, 95%, 95%, 75%, 75%, 75%, 75%, 75%, 75%, and 95% as the measurement values yᵢ and outputs the acquired values to the decision part 113. Further, it is assumed that the value of k is set to 10 and the value of a is set to 9, respectively. It is also assumed that the reference value β is 80% and the reference percentage value γ is 50%.

In this case, first, when the number of times of acquisitions of the measurement value yᵢ becomes ten, the decision part 113 decides whether or not each value from the value of 95% which is the measurement value y₁₀₋₉ nine times before the tenth time to the value of 95% which is the measurement value y₁₀ of the tenth time is less than the reference value β using the binary variable Wᵢ. In this example, according to the above Equations (3) and (4), (0+0+0+1+1+1+1+1+1+0)/10=0.6. Therefore, the decision part 113 calculates a value of 60% as a percentage value of the measurement values yᵢ that are less than the reference value β. Since the percentage value is 50% or more of the reference percentage value γ, the decision part 113 decides that the calculated percentage value Q_{10-9,10} is equal to or greater than the reference percentage value Y. Then, the operation of the dust removal determination device 10 proceeds to processing by the signal generation part 114 next.

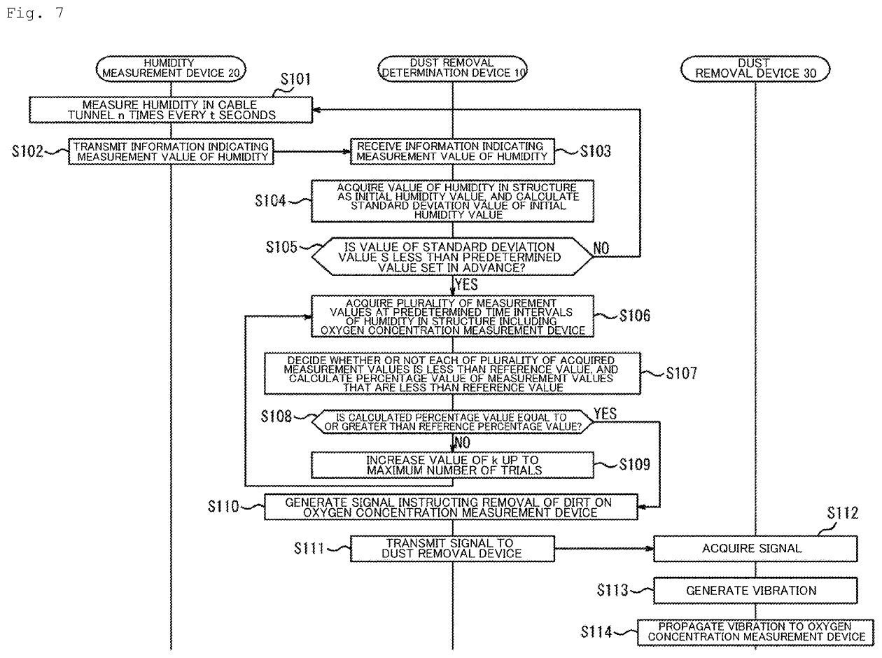

Next, the difference between the operation of the system 1 according to the first embodiment and the operation of the system 1 according to the present embodiment will be described with reference to FIG. 7. Among the operations of the system 1, the operation of the dust removal determination device 10 corresponds to the dust removal determination method according to the present embodiment.

Since the processing from step S101 to step S106 is the same as the processing from step S1 to step S6 in FIG. 6, the description thereof will be omitted.

In step S107, the decision part 113 of the dust removal determination device 10 decides whether or not each of the plurality of acquired measurement values yᵢ is less than a reference value β, and calculates a percentage value Q of the measurement values yᵢ that are less than the reference value β. The reference value β may be arbitrarily set, and is, for example, a value of 80%.

Specifically, when the number of times of acquisitions of the measurement value yᵢ becomes k times or more, the decision part 113 uses measurement values yᵢ from the k-a-th time to the k-th time to calculate a percentage value Q_{k-a,k} according to the above Equations (3) and (4).

In step S108, the decision part 113 decides whether or not the calculated percentage value Q_{k-a,k} is equal to or greater than the reference percentage value γ. The reference percentage value γ may be arbitrarily set, and is, for example, a value of 50%. When the percentage value is less than the reference percentage value γ, the operation of the dust removal determination device 10 proceeds to step S109. When the percentage value is equal to or greater than the reference percentage value γ, the operation of the dust removal determination device 10 proceeds to step S110.

As shown in steps S107 and S108, the decision part 113 decides whether or not each of the plurality of acquired measurement values yᵢ is less than a reference value β, calculates a percentage value Q of the measurement values yᵢ that are less than the reference value β, and decides whether or not the percentage value Q is equal to or greater than a reference percentage value γ. In this way, the decision part 113 decides whether or not the humidity is less than the reference value β by using the measurement value yᵢ.

First, the case where it is determined that the percentage value Q is less than the reference percentage value γ in step S108 and the operation of the dust removal determination device 10 proceeds to step S109 will be described. In step S109, the decision part 113 increases the value of k up to the maximum number of trials m. Thereafter, the operation of the dust removal determination device 10 returns to step S106.

Since the processing from step S110 to step S114 is the same as the processing from step S10 to step S14 in FIG. 6, the description thereof will be omitted.

As described above, in the dust removal determination device 10 according to the present embodiment, the decision part 113 decides whether or not each of the plurality of acquired measurement values is less than the reference value, calculates a percentage value of the measurement values that are less than the reference value, and decides whether or not the percentage value is equal to or greater than a reference percentage value.

According to the present embodiment, it is decided whether or not each of the measurement values yᵢ from the k-a-th time to the k-th time is less than the reference value β each time, and it is possible to ascertain that the cable tunnel has been in the dry state at what percentage of a certain period of time. Therefore, compared to the processing of the decision part according to the first embodiment, it is possible to decide to operate that the dust removal device 30 without being affected by the magnitude of each of the measurement values yᵢ. For example, it is assumed that the acquired measurement values yᵢ are 95%, 95%, 95%, 75%, 75%, 75%, 75%, 75%, 75%, and 95% in order, the value of k is 10, the value of a is 9, and the reference value β is 80%. According to the first embodiment, the average value P_{k-a,k} is 83%, and since this value is equal to or greater than the reference value β, the dust removal device 30 is not operated. However, 60% of the acquired measurement values are less than the reference value β. According to the present embodiment, it is possible to calculate the percentage value in which the dry state has continued without being affected by the magnitude of the measurement value yᵢ in this way.

As described above, according to the present embodiment, it is possible to ascertain that the dry state in the cable tunnel has continued for a certain period of time with higher accuracy. When the dry state continues for a certain period of time, there is a higher likelihood that the dust will fly in the space of the structure such as a cable tunnel, and therefore the removal of the dirt on the oxygen concentration measurement device 40 can be started by the dust removal device 30. Thus, the dust removal device 30 can be operated only when there is a high likelihood that dust has adhered to the filter part 43 of the oxygen concentration measurement device 40. Accordingly, compared to the case where the dust removal device 30 is operated at high frequency, it is possible to suppress an increase in the electricity cost of the entire system, a reduction in the life of the dust removal device 30 due to high frequency use, and an increase in the replacement cycle.

Also, according to the present embodiment, even when the humidity environment in the cable tunnel is suddenly changed and a high humidity state and a low humidity state are switched by work and ventilation in the cable tunnel, continuation of the dry state is accurately ascertained and the dust removal device 30 can be operated. For example, a method is assumed in which the value of a is not set as the number of sampling times as described above, and a signal is transmitted to the dust removal device 30 to operate the dust removal device 30 when the measurement value yᵢ less than the reference value β is simply continued three times. It is assumed that the reference value β is set to a value of 80%, and the measurement value acquisition part 112 acquires the measurement values yᵢ in the order of 75%, 75%, 95%, 75%, and 75%. In this case, according to the present embodiment, 1+1+0+1+⅕=0.8, and the decision part 113 can calculate the percentage value Q of 80% and start the operation of the dust removal device 30. On the other hand, in the method according to this example, since the measurement value yᵢ less than the reference value β is not continued three times, the operation of the dust removal device 30 cannot be started. In this way, in the method according to this example, an event occurs that the dust removal device 30 is not started regardless of a state in which four of the five measurement values yᵢ are less than the reference value β, that is, a substantially dry state.

In this way, according to the present embodiment, by setting the value of a as the number of sampling times for a certain period of time and calculating the percentage value Q of the measurement values yᵢ that are less than the reference value β during the period, even if an event occurs in which a high humidity state and a low humidity state are primarily switched, it is possible to weaken the effect and express the humidity tendency in the cable tunnel. Thus, it is possible to improve a technique for preventing malfunction of the oxygen concentration measurement device 40 caused by contamination.

Although the present disclosure has been described based on the drawings and embodiments, it should be noted that those skilled in the art can easily make various modifications and amendments based on the present disclosure. Therefore, it should be noted that these modifications and amendments are included in the scope of the present disclosure.

The configuration of the dust removal device 30 is not limited to the above-described embodiments. Modifications 1 to 6 as modifications of the configuration of the dust removal device 30 and Modification 7 as a modification of the dust removal determination device 10 will be described below.

### (Modification 1)

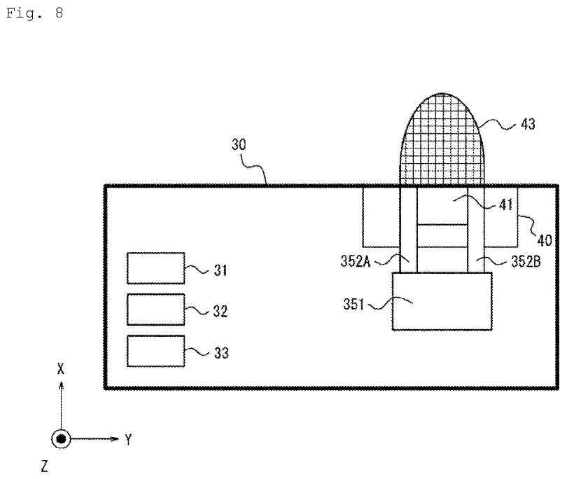

In Modification 1, as illustrated in FIG. 8, the dust removal device 30 includes a wind generator 351, and a plurality of air ducts 352 instead of the vibration unit 34 and the vibration propagation unit 35 described in the first and second embodiments.

The wind generator 351 includes a motor and a propeller connected to a rotating shaft of the motor in a housing. The propeller is rotated by the drive of the motor, and wind is generated. As illustrated in FIG. 8, the wind generator 351 is provided inside the dust removal device 30 and generates wind toward the filter part 43 of the oxygen concentration measurement device 40.

The air duct 352 is a passage through which the wind generated by the wind generator 351 passes and enters the filter part 43. Although the shape of the air duct 352 is not limited, it may be a tubular shape having a circular cross section. In FIG. 8, only two air ducts 352A and 352B are illustrated, but the number of air ducts 352 is not limited thereto. The air duct 352 is provided so that wind is sent into the filter part 43 while avoiding the oxygen concentration sensor 41. Thus, the wind generated by the wind generator 351 can be prevented from directly hitting the oxygen concentration sensor 41.

In the present modification, when the control unit 31 acquires a signal instructing removal of dirt from the dust removal determination device 10, the control unit 31 controls the wind generator 351 to generate wind. The generated wind is sent to the inside of the filter part 43 of the oxygen concentration measurement device 40 through the air ducts 352A and 352B. Thus, the dust on the filter part 43 is blown off, and the dirt on the oxygen concentration measurement device 40 can be removed.

According to the present modification, by using the plurality of air ducts 352 to prevent wind from blowing directly on the oxygen concentration sensor 41, dust adhering to the filter part 43 can be blown off while preventing deterioration of the oxygen concentration sensor 41. Thus, it is possible to improve a technique for preventing malfunction of the oxygen concentration measurement device 40 caused by contamination.

### (Modification 2)

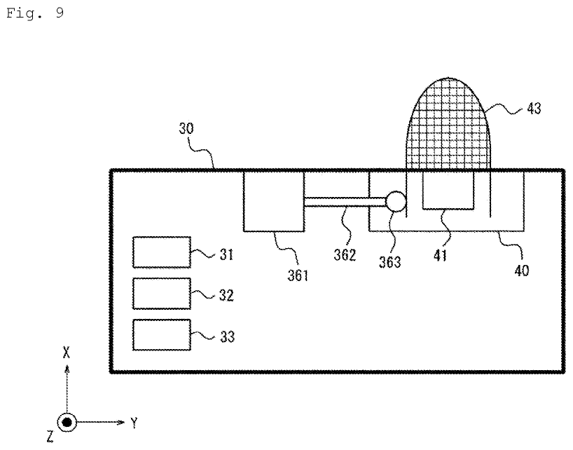

In the present modification, as illustrated in FIG. 9, the dust removal device 30 includes a rotation generator 361, a rotating shaft 362, and a gear part 363 instead of the vibration unit 34 and the vibration propagation unit 35 described in the first and second embodiments.

The rotation generator 361 includes a motor, and the rotating shaft 362 transmits a rotational force by the motor to the outside. Specifically, one end of the rotating shaft 362 is connected to the motor of the rotation generator 361, and the other end thereof is connected to the gear part 363. With reference to FIG. 9, the rotation generator 361 generates a rotational force around a Y-axis, and the rotational force is transmitted to the gear part 363 by the rotating shaft 362. The gear part 363 converts the rotational force around the Y-axis into rotation around the vertical direction of the rotating shaft 362, that is, around an X-axis. The gear part 363 meshes with an arbitrary mechanism such as a gear provided in the filter part 43, and rotates the filter part 43 around the X axis. As the filter part 43 rotates, dust adhering to the outside of the filter part 43 is blown off by centrifugal force, and the dirt on the oxygen concentration measurement device 40 can be removed.

According to the present modification, it is possible to prevent dust from falling into the filter part 43 and adhering to the oxygen concentration sensor 41. That is, dust adhering to the filter part 43 can be blown off while preventing deterioration of the oxygen concentration sensor 41. Thus, it is possible to improve a technique for preventing malfunction of the oxygen concentration measurement device 40 caused by contamination.

### (Modification 3)

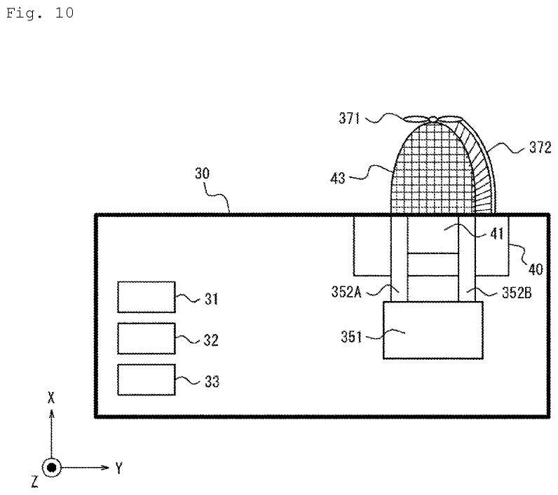

In the present modification, as illustrated in FIG. 10, the dust removal device 30 includes a propeller part 371 rotated by receiving wind from the wind generator 351 at an upper part of the filter part 43, and a brush part 372 connected to one propeller of the propeller part 371 in addition to the wind generator 351 and the plurality of air ducts 352 of Modification 1.

As illustrated in FIG. 10, the propeller part 371 is provided at the projecting tip portion of the filter part 43, and rotates by receiving wind from the wind generator 351. The propeller part 371 includes a plurality of rotary blades, and a brush part 372 is fixed to any one of them. The brush part 372 includes a main body part and a bristle part. The main body part has an elongated shape and extends along the side surface from the projecting tip portion of the filter part 43 to the end part of the filter part 43 on the oxygen concentration measurement device 40 side. One end of the bristle part of the brush part 372 is held by the main body part, and the other end thereof is in contact with the filter part 43. When the brush part 372 rotates around the filter part 43 simultaneously with the rotation of the propeller part 371, the bristle part can blow off dust on the side surface of the filter part 43 and clean it.

According to the present modification, by using the wind generator 351 and the brush part 372 together, it becomes easier to blow off the dust on the filter part 43 to the outside, and it is possible to enhance the dust removing effect. By providing the brush part 372 outside the filter part 43, it is possible to prevent impurities from falling to the oxygen concentration sensor 41 during rotation.

Further, although the surface area of the bristle part of the brush part 372 can be set to an arbitrary size, by constituting the bristle part so as to have an elongated shape like the main body part to reduce the surface area, it is possible to prevent the suction of outside air from being hindered when the oxygen concentration sensor 41 measures the oxygen concentration.

Further, by making the brush part 372 curved along the side surface of the filter part 43, the brush part 372 can rotate to clean the entire surface of the filter part 43. In addition, by providing the wind generator 351 inside the dust removal device 30, the generated wind can blow off the impurities adhering to the oxygen concentration sensor 41 from the inside, and the impurities can be prevented from falling to the oxygen concentration sensor 41.

With reference to FIG. 10, the dust removal device 30 according to the present modification sends the air from the wind generator 351 to the filter part 43 and the brush part 372 using the plurality of air ducts 352. Thus, the wind generated by the wind generator 351 can be prevented from directly hitting the oxygen concentration sensor 41.

Thus, the wind does not directly hit the oxygen concentration sensor 41, and dust adhering to the filter part 43 can be blown off while preventing deterioration of the oxygen concentration sensor 41. Thus, it is possible to improve a technique for preventing malfunction of the oxygen concentration measurement device 40 caused by contamination.

### (Modification 4)

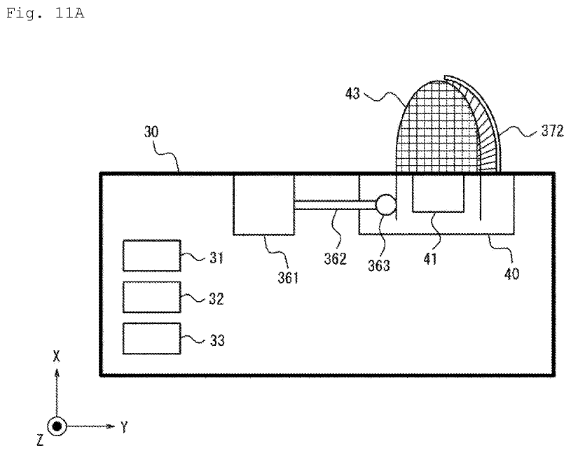

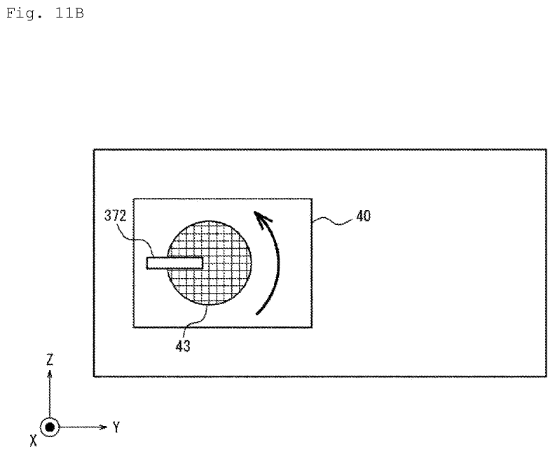

In the present modification, as illustrated in FIG. 11A, the dust removal device 30 includes a brush part 372 in addition to the rotation generator 361, the rotating shaft 362, and the gear part 363 of Modification 2.

As illustrated in FIG. 11A, the brush part 372 is fixed on the oxygen concentration measurement device 40. The brush part 372 may be fixed on the dust removal device 30. The brush part 372 includes a main body part and a bristle part, and the main body part has an elongated shape and extends along the side surface from the projecting tip portion of the filter part 43 to the end part of the filter part 43 on the oxygen concentration measurement device 40 side. One end of the bristle part of the brush part 372 is held by the main body part, and the other end thereof is in contact with the filter part 43.

The filter part 43 rotates around the X-axis by receiving the rotational force generated by the rotation generator 361 via the rotating shaft 362 and the gear part 363. As the filter part 43 rotates, the bristle part of the brush part 372 in contact with the filter part 43 can blow off dust on the side surface of the filter part 43 and clean it.

FIG. 11B is a side view of the dust removal device 30 and the oxygen concentration measurement device 40 according to the present modification. The filter part 43 rotates in the direction of an arrow around the X-axis by the rotational force from the rotation generator 361. As the filter part 43 rotates, the bristle part of the brush part 372 blows off dust on the side surface of the filter part 43 and cleans it.

According to the present modification, by using the rotation generator 361 and the brush part 372 together, it becomes easier to efficiently blow off the dust on the filter part 43 to the outside, and it is possible to enhance the dust removing effect. By installing the brush part 372 outside the filter part 43, it is possible to prevent impurities from falling to the oxygen concentration sensor 41 during rotation of the filter part 43.

Further, although the surface area of the bristle part of the brush part 372 can be set to an arbitrary size, by constituting the bristle part so as to have an elongated shape like the main body part to reduce the surface area, it is possible to prevent the suction of outside air from being hindered when the oxygen concentration sensor 41 measures the oxygen concentration.

Further, by making the brush part 372 curved along the side surface of the filter part 43, the brush part 372 can clean the entire surface of the filter part 43 by the rotation of the filter part 43. Further, by installing the rotation generator 361 inside the dust removal device 30, it is possible to prevent deterioration of the rotation generator 361 due to environmental factors such as high humidity.

As described above, according to the present modification, it is possible to improve a technique for preventing malfunction of the oxygen concentration measurement device 40 caused by contamination.

### (Modification 5)

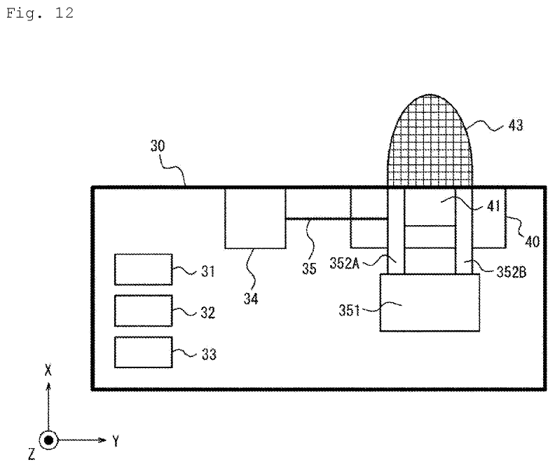

The dust removal device 30 may have a configuration in which the above-described first embodiment and Modification 1 are combined. As illustrated in FIG. 12, the dust removal device 30 according to the present modification includes a vibration unit 34, a vibration propagation unit 35, a wind generator 351, and a plurality of air ducts 352.

In the present modification, when the control unit 31 acquires a signal instructing removal of dirt from the dust removal determination device 10, the control unit 31 controls the vibration propagation unit 35 to generate vibration and also controls the wind generator 351 to generate wind. The vibration generated from the vibration propagation unit 35 propagates to the filter part 43 via the vibration propagation unit 35. The dust can be floated and dropped by the vibration of the filter part 43. At this time, the wind generated from the wind generator 351 is sent to the inside of the filter part 43 via the air ducts 352A and 352B, and the dust can be blown off.

By providing the wind generator 351 inside the dust removal device 30, the generated wind can blow off the impurities adhering to the oxygen concentration sensor 41 from the inside, and the impurities can be prevented from falling to the oxygen concentration sensor 41. By using the wind generator 351 and the vibration unit 34 together, the dust on the filter part 43 can be floated and then blown off, and it is possible to further enhance the dust removal effect.

In addition, by using the plurality of air ducts 352 to prevent wind from blowing directly on the oxygen concentration sensor 41, dust adhering to the filter part 43 can be blown off while preventing deterioration of the oxygen concentration sensor 41. Thus, it is possible to improve a technique for preventing malfunction of the oxygen concentration measurement device 40 caused by contamination.

### (Modification 6)

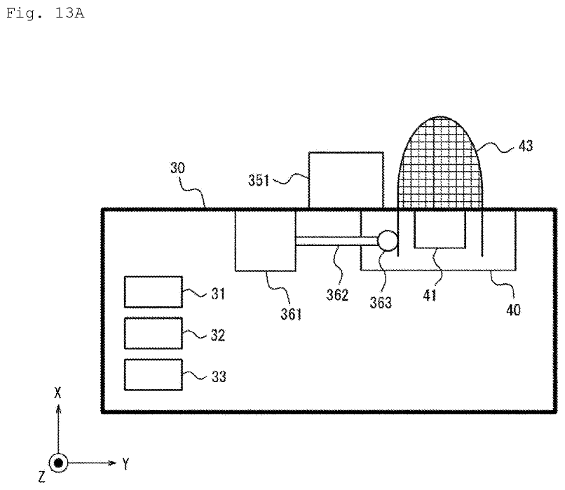

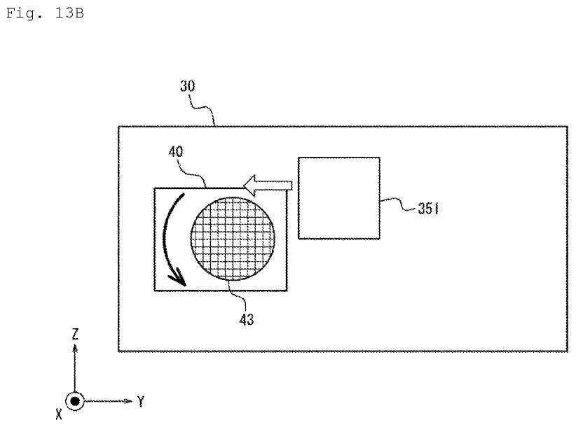

The dust removal device 30 may have a configuration in which the above-described Modification 1 and Modification 2 are combined. As illustrated in FIG. 13A, the dust removal device 30 according to the present modification includes a wind generator 351, a rotation generator 361, a rotating shaft 362, and a gear part 363. In the present modification, the wind generator 351 is provided outside the dust removal device 30, and sends wind directly to the filter part 43 of the oxygen concentration measurement device 40 without passing through the air duct 352.

In the present modification, when the control unit 31 acquires a signal instructing removal of dirt from the dust removal determination device 10, the control unit 31 controls the rotation generator 361 to generate a rotational force and also controls the wind generator 351 to generate wind. The rotational force generated by the rotation generator 361 is propagated to the filter part 43 via the rotating shaft 362 and the gear part 363. As the filter part 43 rotates, the dust is floated and dropped by centrifugal force. At this time, the wind generated from the wind generator 351 is sent to the filter part 43, and the dust can be blown off.

FIG. 13B is a side view of the dust removal device 30 and the oxygen concentration measurement device 40 according to the present modification. In FIG. 13B, a white arrow indicates a direction in which wind is sent from the wind generator 351, and a black arrow indicates a direction in which the filter part 43 is rotated. As illustrated in FIG. 13B, in the present modification, the wind generator 351 sends wind in the tangential direction of the filter part 43 having a circular bottom surface and in the forward direction of the rotation of the filter part 43. Thus, the dust can be removed in the form of pushing out the dust to the outside of the filter part 43. Further, the dust is not dropped inside the filter part 43, and the deterioration of the oxygen concentration sensor 41 can be prevented.

According to the present modification, by using the rotation generator 361 and the wind generator 351 together, it is possible to enhance the effect of blowing off dust by centrifugal force and wind force, and further enhance the dust removing effect. Further, by installing the rotation generator 361 inside the dust removal device 30, it is possible to prevent deterioration of the rotation generator 361 due to environmental factors such as high humidity.

As described above, according to the present modification, it is possible to improve a technique for preventing malfunction of the oxygen concentration measurement device 40 caused by contamination.

### (Modification 7)

As a modification of the dust removal determination device 10, the first embodiment and the second embodiment may be combined to perform both the processing of the decision part 113 according to the first embodiment and the processing of the decision part 113 according to the second embodiment.

Specifically, the decision part 113 first calculates an average value P of the plurality of acquired measurement values yᵢ, decides whether or not the average value P is less than the reference value β, and stores the result in the storage unit 12 as a first result. Next, the decision part 113 decides whether or not each of the plurality of identical measurement values yᵢ is less than a reference value β, calculates a percentage value Q of the measurement values yᵢ that are less than the reference value β, decides whether or not the percentage value Q is equal to or greater than a reference percentage value γ, and stores the result in the storage unit 12 as a second result.

In the present modification, the signal generation part 114 generates a signal instructing removal of dirt on the oxygen concentration measurement device 40 according to a combination of the first result and the second result. The combination can be freely set. For example, the decision part 113 decides that the removal of dirt by the dust removal device 30 is necessary when the average value P is less than the reference value β in the first result or when the percentage value Q is equal to or greater than the reference percentage value γ in the second result. Then, according to the decision, the signal generation part 114 generates a signal instructing removal of dirt on the oxygen concentration measurement device 40. That is, the decision part 113 decides that the removal of dirt by the dust removal device 30 is unnecessary only when the average value P is equal to or greater than the reference value β in the first result and the percentage value Q is less than the reference percentage value γ in the second result.

According to the present modification, compared to the case where only the processing of the decision part 113 of either the first embodiment or the second embodiment is performed, the humidity state in the cable tunnel can be expressed more accurately, and whether the dust removal device 30 is operated or not can be decided. Therefore, according to the present modification, it is possible to improve the technique for preventing malfunction of the oxygen concentration measurement device 40 caused by contamination.

Regarding the above embodiment, the following supplementary notes are further disclosed.

### (Supplementary Note 1)

A dust removal determination device comprising a control unit configured to:
acquire a plurality of measurement values at predetermined time intervals of humidity in a structure including an oxygen concentration measurement device;
decide whether or not the humidity is less than a reference value by using the measurement values; and generate a signal instructing removal of dirt on the oxygen concentration measurement device according to the decision.

### (Supplementary Note 2)

The dust removal determination device according to Supplementary Note 1, wherein the control unit calculates an average value of the plurality of acquired measurement values, and decides whether or not the average value is less than the reference value.

### (Supplementary Note 3)

The dust removal determination device according to Supplementary Note 1, wherein the control unit decides whether or not each of the plurality of acquired measurement values is less than the reference value, calculates a percentage value of the measurement values that are less than the reference value, and decides whether or not the percentage value is equal to or greater than a reference percentage value.

### (Supplementary Note 4)

The dust removal determination device according to any one of Supplementary Notes 1 to 3, wherein the control unit acquires a humidity value in the structure as an initial humidity value, calculates a standard deviation value of the initial humidity value, and decides determination propriety as to whether to remove the dirt based on whether or not the standard deviation value is less than a predetermined value.

### (Supplementary Note 5)

A dust removal device that communicates with the dust removal determination device according to any one of Supplementary Notes 1 to 4,
wherein the oxygen concentration measurement device includes a filter part that prevents impurities from entering the oxygen concentration measurement device, and
the dust removal device includes:
   a control unit that acquires a signal instructing removal of the dirt from the dust removal determination device; and
   a vibration unit that removes dust on the filter part by applying vibration to the filter part according to the acquired signal.

### (Supplementary Note 6)

A dust removal determination method comprising:
an acquisition step of acquiring a plurality of measurement values at predetermined time intervals of humidity in a structure including an oxygen concentration measurement device;
a decision step of deciding whether or not the humidity is less than a reference value by using the measurement values; and
a generation step of generating a signal instructing removal of dirt on the oxygen concentration measurement device according to the decision in the decision step.

### (Supplementary Note 7)

The dust removal determination method according to Supplementary Note 6, wherein the decision step includes calculating an average value of the plurality of acquired measurement values, and deciding whether or not the average value is less than the reference value.

### (Supplementary Note 8)

The dust removal determination method according to Supplementary Note 6, wherein the decision step includes deciding whether or not each of the plurality of acquired measurement values is less than the reference value, calculating a percentage value of the measurement values that are less than the reference value, and deciding whether or not the percentage value is equal to or greater than a reference percentage value.

### REFERENCE SIGNS LIST

1 System
10 Dust removal determination device
11 Control unit
12 Storage unit
13 Communication unit
14 Input unit
15 Output unit
20 Humidity measurement device
21 Control unit
22 Storage unit
23 Communication unit
24 Input unit
25 Output unit
26 Humidity sensor
30 Dust removal device
31 Control unit
32 Storage unit
33 Communication unit
34 Vibration unit
35 Vibration propagation unit
40 Oxygen concentration measurement device
41 Oxygen concentration sensor
42 Suction port
43 Filter part
111 Determination propriety decision part
112 Measurement value acquisition part
113 Decision part
114 Signal generation part
351 Wind generator
352, 352A, 352B Air duct
361 Rotation generator
362 Rotating shaft
363 Gear part
371 Propeller part
372 Brush part

1. A dust removal determination device comprising a processor configured to execute operations comprising:
acquiring a plurality of measurement values at predetermined time intervals of humidity in a structure, the structure including an oxygen concentration measurement device;
determining whether the humidity is less than a reference value by using the measurement values; and
generating a signal, the signal instructing removal of dirt on the oxygen concentration measurement device according to the determination.

2. The dust removal determination device according to claim 1, wherein the determining further comprises:
calculating an average value of the plurality of acquired measurement values, and
determining whether the average value is less than the reference value.

3. The dust removal determination device according to claim 1, wherein the determining further comprises:
determining whether each of the plurality of acquired measurement values is less than the reference value,
calculating a percentage value of the measurement values that are less than the reference value, and
determining whether the percentage value is equal to or greater than a reference percentage value.

4. The dust removal determination device according to claim 1, the processor further configured to execute operations comprising:
acquiring a humidity value in the structure as an initial humidity value;
calculating a standard deviation value of the initial humidity value; and
determining whether to remove the dirt based on whether or not the standard deviation value is less than a predetermined value.

5. A dust removal device comprising a processor configured to execute operations comprising:
acquiring a signal, the signal instructing removal of dirt; and
removing dust on a filter part of an oxygen concentration measurement device by applying vibration to the filter part according to the acquired signal.

6. A method for determining dust removal, comprising:
an acquisition step of acquiring a plurality of measurement values at predetermined time intervals of humidity in a structure, the structure including an oxygen concentration measurement device;
a determination step of determining whether or not the humidity is less than a reference value by using the measurement values; and
a generation step of generating a signal, the signal instructing removal of dirt on the oxygen concentration measurement device according to the determination.

7. The method according to claim 6, wherein the deciding further comprises:
calculating an average value of the plurality of acquired measurement values, and
deciding whether the average value is less than the reference value.

8. The method according to claim 6, wherein the determining further comprises:
determining whether each of the plurality of acquired measurement values is less than the reference value,
calculating a percentage value of the measurement values that are less than the reference value, and
determining whether the percentage value is equal to or greater than a reference percentage value.

9. The device according to claim 2, the processor further configured to execute operations comprising:
acquiring a humidity value in the structure as an initial humidity value;
calculating a standard deviation value of the initial humidity value; and
determining whether to remove the dirt based on whether the standard deviation value is less than a predetermined value.

10. The device according to claim 3, the processor further configured to execute operations comprising:
acquiring a humidity value in the structure as an initial humidity value;
calculating a standard deviation value of the initial humidity value; and
determining whether to remove the dirt based on whether the standard deviation value is less than a predetermined value.

11. The method according to claim 6, further comprising:
acquiring a humidity value in the structure as an initial humidity value;
calculating a standard deviation value of the initial humidity value; and
determining whether to remove the dirt based on whether or not the standard deviation value is less than a predetermined value.

12. The method according to claim 7, further comprising:
acquiring a humidity value in the structure as an initial humidity value;
calculating a standard deviation value of the initial humidity value; and
determining whether to remove the dirt based on whether the standard deviation value is less than a predetermined value.

13. The method according to claim 8, further comprising:
acquiring a humidity value in the structure as an initial humidity value;
calculating a standard deviation value of the initial humidity value; and
determining whether to remove the dirt based on whether the standard deviation value is less than a predetermined value.
